(19) United States
(12) Patent Application Publication
(10) Pub. No.: US 2012/0140026 A1
(43) Pub. Date: Jun. 7, 2012

(54) 2D-to-3D COLOR COMPENSATION SYSTEM AND METHOD THEREOF

(75) Inventors: SHIN-SHIUAN CHENG, TAINAN (TW); SHU-MING LIU, TAINAN (TW)

(73) Assignee: HIMAX MEDIA SOLUTIONS, INC., TAINAN (TW)

(21) Appl. No.: 12/961,338

(22) Filed: Dec. 6, 2010

(51) Int. Cl. H04N 13/00; G09G 5/02

(52) U.S. Cl. 348/43; 345/589; 348/E13.068

(57) ABSTRACT

A 2D-to-3D color compensation method for compensating color processing in a display device is disclosed. The display device is coupled with a 2D-to-3D conversion box. The method includes the following steps: firstly, the 2D-to-3D conversion box sends out a combined calibration pattern to the display device. Then, the display device performs image processing for the combined calibration pattern. Subsequently, detect a difference value between the combined calibration pattern processed by the display device and the original combined calibration pattern. Finally, adjust the combined calibration pattern according to the difference value.

### BACKGROUND OF THE INVENTION

1. Field of the Invention

The present invention generally relates to color compensation system, and more particularly to a 2D-to-3D color compensation system and method thereof.

2. Description of Related Art

Formerly the video displayed in a panel display device such as a liquid crystal display (LCD) TV is a two-dimensional (2D) image source. In the wake of developments in displaying technology, the applications of displaying three-dimensional (3D) visual effect have increased with each passing day, such as 3D films, 3D games, and product displaying, etc. It results that the 3D imaging system becomes more practical and popular.

Besides using 3D display to achieve 3D imaging effect, the displays with general functions can be connected with a 2D-to-3D conversion box to generate 3D visual effect as well. Please refer to FIG. 1, which shows a block diagram of a conventional 2D-to-3D imaging system 1. The 2D-to-3D imaging system 1, which comprises a 2D-to-3D conversion box 13, and a pair of 2D-to-3D red/cyan glasses (or Anaglyph glasses) 15, is tied in with a display device 11. The 2D-to-3D conversion box 13 is connected with the display device 11, and is configured to split each frame of the input 2D video source into a left-eye image and a right-eye image, and then merge them. The merged frames then may be transmitted to the display device 11 to display. Specifically, it can be implemented by the color-filtered technology in the 2D-to-3D conversion box 13 to filter red pixels and blue/green pixels respectively for each frame, and then merge both interlaced.

The pair of red/cyan glasses 15 comprises a left (L) lens 151 and a right (R) lens 153, which only receive the frames with corresponding color respectively. For example, only red pixels parts of frames can pass through the left lens 151, and only blue/green pixels parts of frames can pass through the right lens 153. Therefore, when the viewer wears the pair of red/cyan glasses 15 to view the video source displayed by the display device 11, the 3D visual effect would be generated owing to binocular disparity between the left-eye image and the right-eye image.

However, before displaying the filtered images which is sent to the display device 11, the video content would be conducted certain color processing by the image processor 111 embedded in the display device 11. This additional color manipulation by the display device 11 itself distorts the purposely arrange RGB information intended for the right (cyan, for example) and left (red, for example) eyes, separately. As a result, the viewer's 3D impression will be adversely impacted.

For the reason that conventional 2D-to-3D imaging system could not effectively display 3D image or video owing to the color processing, a need has arisen to propose a novel color compensation system and method to compensate the color distortion due to image processing and improve 3D visual effect.

### SUMMARY OF THE INVENTION

In view of the foregoing, it is an object of the embodiment of the present invention to provide a 2D-to-3D color compensation system and method thereof to compensate the color distortion caused by the display device to perform image processing for the screen right and left images.

According to one embodiment, a 2D-to-3D color compensation system tied in with a display device comprises a 2D-to-3D conversion box and a color calibration device. The 2D-to-3D conversion box is coupled with the display device and sends out at least one combined calibration pattern to the display device to display. Wherein the combined calibration pattern is composed of a screen left image with a first color and a screen right image with a second color. The color calibration device is configured for detecting a difference value between the combined calibration pattern processed by the display device and the original combined calibration pattern. Accordingly, the 2D-to-3D conversion box adjusts the combined calibration pattern according to the difference value.

According to another embodiment, a 2D-to-3D color compensation method for compensating color processing in a display device is disclosed. The display device is coupled with a 2D-to-3D conversion box. The method includes the following steps: firstly, the 2D-to-3D conversion box sends out a combined calibration pattern to the display device. Then, the display device performs image processing for the combined calibration pattern. Subsequently, detect a difference value between the combined calibration pattern processed by the display device and the original combined calibration pattern. Finally, adjust the combined calibration pattern according to the difference value.

### BRIEF DESCRIPTION OF THE DRAWINGS

FIG. 1 shows a block diagram of a conventional 2D-to-3D imaging system;

FIG. 2 shows a block diagram illustrating a 2D-to-3D color compensation system according to one embodiment of the present invention; and

FIG. 3 shows a flow diagram illustrating a 2D-to-3D color compensation method according to one embodiment of the present invention.

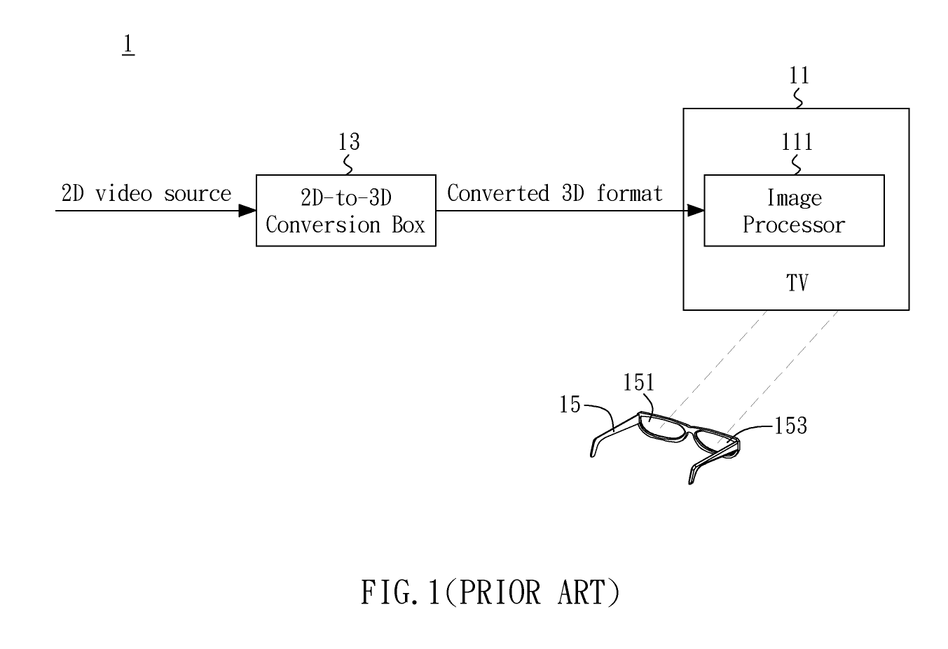

### DETAILED DESCRIPTION OF THE INVENTION

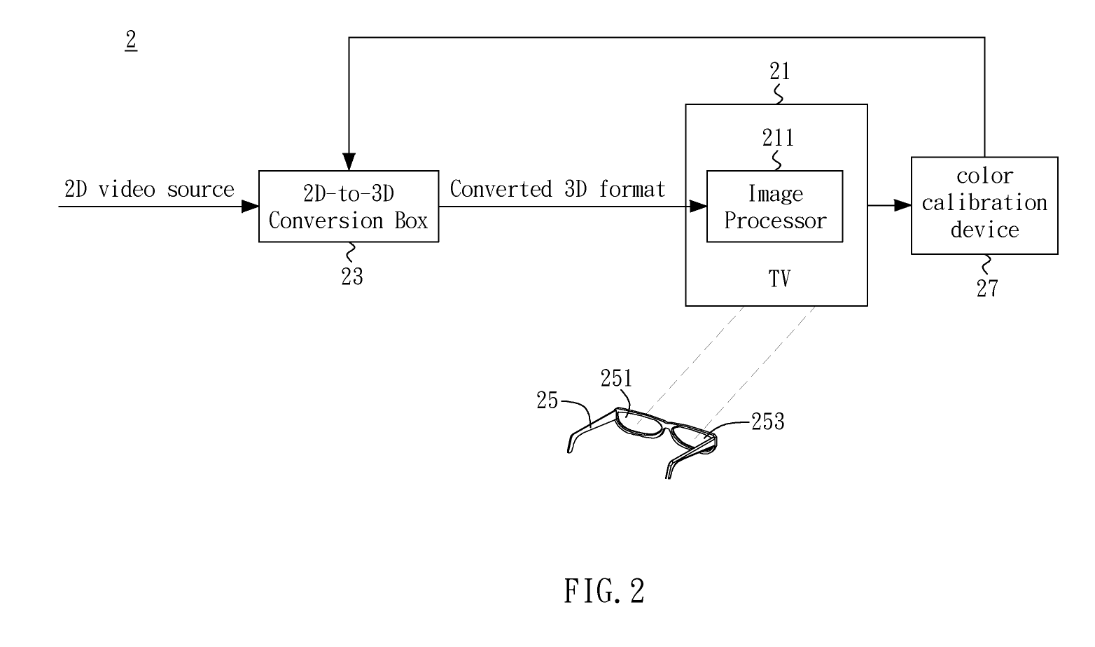

FIG. 2 is a block diagram illustrating a 2D-to-3D color compensation system according to one embodiment of the present invention. The 2D-to-3D color compensation system 2, as shown in FIG. 2, comprising a 2D-to-3D conversion box 23, a color calibration device 27, and a pair of 2D-to-3D red/cyan glasses (or Anaglyph glasses) 25, is tied in with a display device 21. The 2D-to-3D conversion box 23 is connected with the display device 21, and is configured to convert an input 2D video source to a converted 3D output format. The converted 3D output format frames then may be transmitted to the display device 21 to display.

Specifically, the 2D video source includes a series of frames. It may be implemented by the color-filtered technology in the 2D-to-3D conversion box 23 to filter red pixels and blue/green pixels respectively for each frame, and further generate a screen left image with red color and a screen right image with blue/green color. The screen left image only stores red pixels information, and the screen right image only stores blue/green pixels information. The 2D-to-3D conversion box 23 will merge the screen left image and the screen right image interlaced and then send it to display device 21.

The pair of red/cyan glasses 25 comprises a left (L) lens 251 and a right (R) lens 253, which only receive the frames with corresponding color respectively. For example, only red pixels parts of frames (i.e. screen left image) can pass through the left lens 251, and only blue/green pixels parts of frames (i.e. screen right image) can pass through the right lens 253. Therefore, when the viewer wears the pair of red/cyan glasses 25 to view the video source displayed by the display device 21, the 3D visual effect would be generated owing to binocular disparity between the left-eye image and the right-eye image. For example, the 2D-to-3D conversion box 23 converts the input 2D video source, e.g. 60 Hz progressive, to a converted 3D output format, e.g. 60 Hz red and cyan frames for each side of the pair of red/cyan glasses application.

The display device 21 comprises an image processor 211 which is configured to perform various image processing, such as luminance, color or contrast adjustment, for the converted left and right images, and then displays the processed screen left and right images to be received by the left and right lenses 251 and 253, respectively. In one embodiment, the display device 21 may be, but is not limited to, a Plasma Display Panel (PDP), Plasma TV, Liquid Crystal Display (LCD) TV, or Cathode Ray Tube (CRT) TV.

The 2D-to-3D conversion box 23 pre-stores tailor-made special prime calibration patterns. Each prime calibration pattern may be split into a screen left image with red color and a screen right image with blue/green color, and then merged into a combined calibration pattern to display. In one embodiment, the prime calibration pattern can be, but is not limited to, a completely red pattern, for example, a completely red frame. Before converting the 2D video source, the 2D-to-3D conversion box 23 sends out the combined calibration pattern to the display device 21, detects the pixels modified due to image processing by the display device 21, and further compensates the following images according to adjustment range.

The color calibration device 27 is configured inside the display device 21 or is coupled with the display device 21, but is not limited to this. The color calibration device 27 scans the displaying color of the combined calibration pattern which has processed by the display device 21, and compares it with the original combined calibration pattern (or the prime calibration pattern) to attain a difference value between both. The color calibration device 27 further determines whether the difference value is less than a threshold or not. If no, it means that the difference between the combined calibration pattern which has processed and the original combined calibration pattern is too large to view perfectly screen left image and screen right image. Therefore, the color calibration device 27 transmits the difference value to the 2D-to-3D conversion box 23, and the 2D-to-3D conversion box 23 adjusts the pixels value of the combined calibration pattern according to the difference value.

On the contrary, if the difference value is less than the threshold, it means that the combined calibration pattern which has processed is similar to or equal to the original combined calibration pattern without color distortion, the color calibration device 27 sends out a calibrated signal to the 2D-to-3D conversion box 23 to stop adjusting the combined calibration pattern. Accordingly, the screen left and right images of the 2D video source would be compensated according to the adjustment range of the combined calibration pattern. Wherein, the threshold can be set in accordance with practical applications, such as the sum of the pixel difference excesses 5 pixels.

For example, the image processor 211 of the display device 21 adds 10 in each red pixel for the combined calibration pattern. After scanning the frame processed by the image processor 211 and comparing it with original combined calibration pattern, the color calibration device 27 sends out the above difference value, i.e. 10 pixels, to the 2D-to-3D conversion box 23. The 2D-to-3D conversion box 23 may subtract 10 in each red pixel for the combined calibration pattern or any other frame in advance to achieve compensation before sending the frames to display device 21.

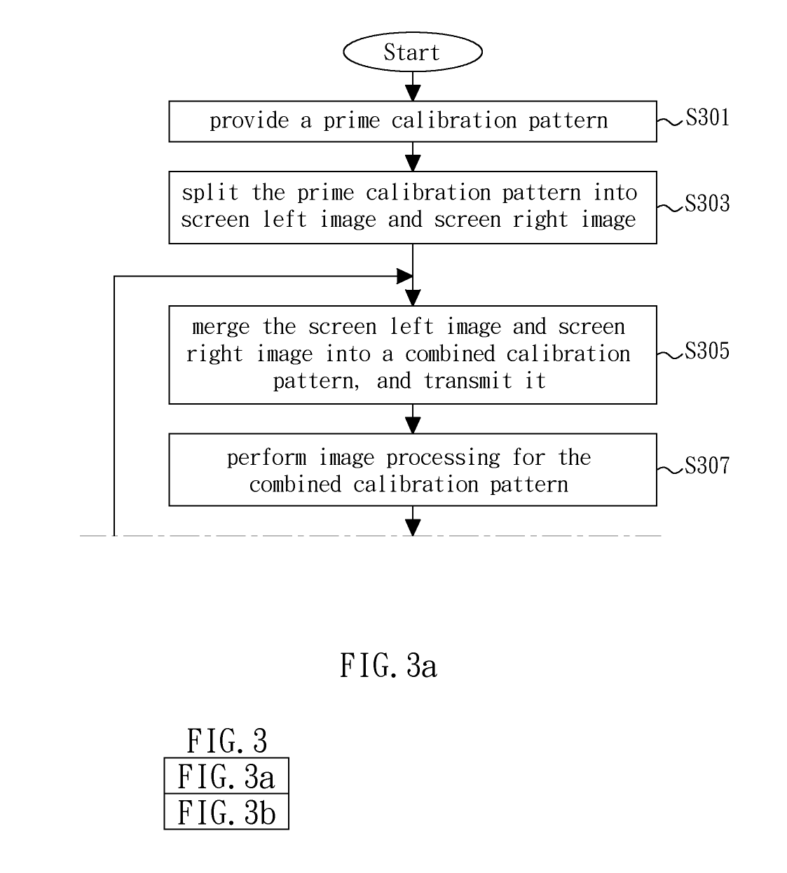

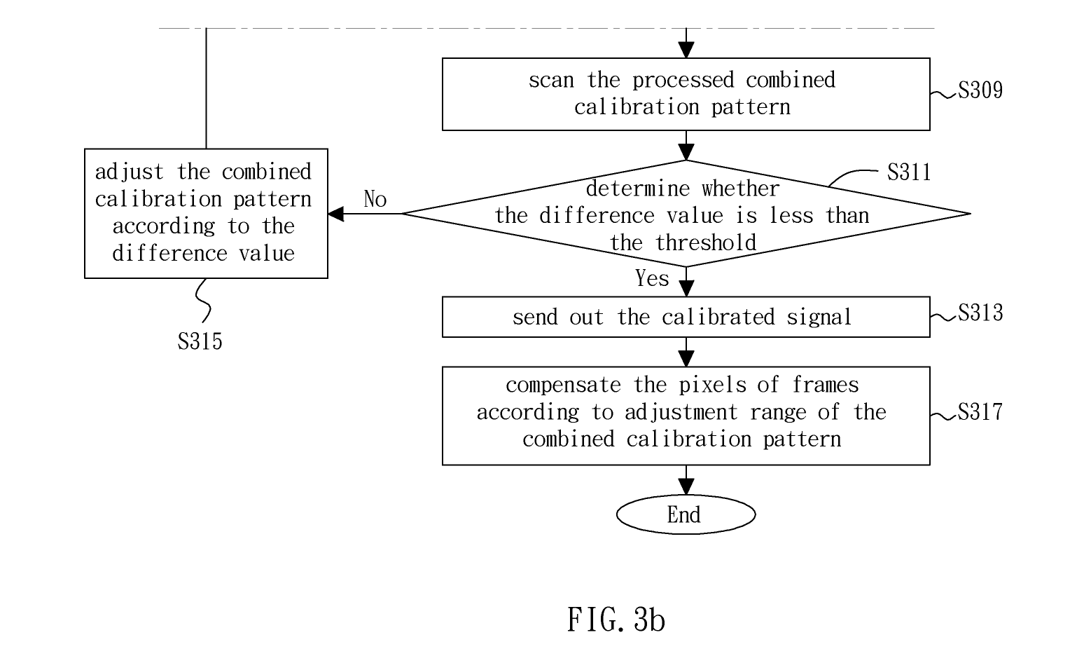

FIG. 3 is a flow diagram illustrating a 2D-to-3D color compensation method according to one embodiment of the present invention. The method comprises the following steps.

When first-time use of this setup or every time a new display device is used, the 2D-to-3D color compensation system 2 needs to be initialized with a calibration phase to ensure quality 3D viewing experience. Firstly, in step S301, a prime calibration pattern is pre-provided in the 2D-to-3D conversion box 23. The 2D-to-3D conversion box 23 splits the prime calibration pattern into a screen left image and a screen right image by the color-filtered technology in step S303, and then further merges the screen left image and the screen right image into a combined calibration pattern, transmits it to the display device 21 in step S305.

After receiving the combined calibration pattern, in step S307, the display device 21 performs image processing for it. Sequentially, the color calibration device 27 scans the combined calibration pattern processed in step S309, and detects the difference between it and original combined calibration pattern. The color calibration device 27 determines whether the difference value is less than a threshold or not in step S311. If yes, it indicates that the combined calibration pattern processed still could be split into left-eye and right-eye frames with perfectly 3D visual effect, the color calibration device 27 sends out a calibrated signal to the 2D-to-3D conversion box 23 in step S313.

If the difference value is not less than the threshold, it indicates that the RGB pixels of the combined calibration pattern are modified too much, which result in color distortion and reducing 3D visual effect. Therefore, in step S315, the 2D-to-3D conversion box 23 adjusts the combined calibration pattern according to the difference value and repeats the steps S305-S311 until the calibrated signal is received. After finishing the above initialized process, the pixels of all frames of the 2D video source could be compensated according to adjustment range of the combined calibration pattern in step S317. Accordingly, the screen frames received by left and right lens will be adaptively compensated, and the perfectly 3D visual effect is achieved.

Although specific embodiments have been illustrated and described, it will be appreciated by those skilled in the art that various modifications may be made without departing from the scope of the present invention, which is intended to be limited solely by the appended claims.

What is claimed is:

1. A 2D-to-3D color compensation system tied in with a display device, comprising:
a 2D-to-3D conversion box coupled with the display device, the 2D-to-3D conversion box being configured to send out at least one combined calibration pattern to the display device, wherein the combined calibration pattern is composed of a screen left image with a first color and a screen right image with a second color; and
a color calibration device configured for detecting a difference value between the combined calibration pattern processed by the display device and the original combined calibration pattern;
wherein, the 2D-to-3D conversion box adjusts the combined calibration pattern according to the difference value.

2. The system of claim 1, wherein if the difference value is less than a threshold, the color calibration device sends out a calibrated signal to the 2D-to-3D conversion box to stop adjusting the combined calibration pattern.

3. The system of claim 2, wherein the 2D-to-3D conversion box pre-stores a prime calibration pattern and splits it into the screen left image and the screen right image, and then merges them into the combined calibration pattern.

4. The system of claim 3, wherein the prime calibration pattern is a completely red pattern.

5. The system of claim 1, wherein the first color is red, and the second color is blue/green.

6. The system of claim 1, further comprising:
a pair of red/cyan glasses comprising a left lens and a right lens, which receive the screen left image and the screen right image respectively.

7. The system of claim 6, wherein only the parts with the first color of the combined calibration pattern can pass through the left lens, and only the parts with the second color of the combined calibration pattern can pass through the right lens.

8. The system of claim 1, wherein the color calibration device is disposed inside the display device or is coupled with the display device.

9. The system of claim 1, wherein the display device comprises a Plasma Display Panel (PDP), Plasma TV, Liquid Crystal Display (LCD) TV or Cathode Ray Tube (CRT) TV.

10. A 2D-to-3D color compensation method for compensating color processing in a display device, the display device is coupled with a 2D-to-3D conversion box, and the method comprising:
sending out at least one combined calibration pattern to the display device by the 2D-to-3D conversion box, wherein the combined calibration pattern is composed of a screen left image with a first color and a screen right image with a second color;
performing image processing for the combined calibration pattern;
detecting a difference value between the combined calibration pattern processed and the original combined calibration pattern; and
adjusting the combined calibration pattern according to the difference value.

11. The method of claim 10, wherein before the step of sending out the combined calibration pattern comprises:
pre-providing a prime calibration pattern;
splitting the prime calibration pattern into the screen left image and the screen right image; and
merging the screen left image and the screen right image into the combined calibration pattern.

12. The method of claim 11, further comprising:
determining whether the difference value is less than a threshold;
if the above result is true, the color calibration device sends out a calibrated signal to the 2D-to-3D conversion box to stop adjusting the combined calibration pattern; and
if the above result is false, the combined calibration pattern is adjusted according to the difference value.

13. The method of claim 11, wherein the prime calibration pattern is a completely red pattern.

14. The method of claim 10, wherein the first color is red, and the second color is blue/green.

15. The method of claim 12, wherein after the step of stop adjusting the combined calibration pattern comprises:
compensating the screen left image and the screen right image of a video source according to adjustment range of the combined calibration pattern.

16. The method of claim 10, wherein the display device comprises a Plasma Display Panel (PDP), Plasma TV, Liquid Crystal Display (LCD) TV or Cathode Ray Tube (CRT) TV.
